(19) United States
(12) Patent Application Publication
(10) Pub. No.: US 2010/0272963 A1
(43) Pub. Date: Oct. 28, 2010

(54) HOUSING HAVING WOVEN APPEARANCE AND MANUFACTURING METHOD THEREOF

(75) Inventors: BIN LI, Shenzhen City (CN); BIN WANG, Shenzhen City (CN); FENG CHU, Shenzhen City (CN); RUI LIU, Shenzhen City (CN); GUI-YUN YANG, Shenzhen City (CN); CHAO-HSUN LIN, Taipei (TW)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/616,319

(22) Filed: Nov. 11, 2009

(30) Foreign Application Priority Data
Apr. 27, 2009 (CN) 200910301874.X

(51) Int. Cl. B32B 3/30; B44C 1/22

(52) U.S. Cl. 428/167; 216/48

(57) ABSTRACT

A housing having a woven appearance includes a substrate and a plurality of groove groups formed on the surface of the substrate. The groove groups define the woven appearance and are formed by etching. The housing may be made by using a film having a lightproof areas and a light-transmissible areas, the lightproof areas defining a woven appearance. The film is placed over a metal substrate having light-sensitive materials formed thereon and radiated with light. The light passing through the light-transmissible areas of the film solidifies the light-sensitive materials. After, removing the film from the substrate and cleaning un-solidified light-sensitive materials from the substrate to expose areas corresponding to the lightproof area, and an etching process is carried out to form the woven appearance on the exposed areas.

### BACKGROUND

1. Technical Field

The present disclosure relates to a housing having a woven appearance and a manufacturing method thereof.

2. Description of Related Art

With developments in electronic products, consumers have being paying more attention to the external appearance of electronic products. Electronic products having woven appearance housings are highly desirable. Methods of forming a woven appearance on a housing include wire-drawing, hot pressing and CNC numerical control machine engraving. However, the woven appearance formed by wire-drawing looks too two-dimensional; the woven appearance formed by hot pressing cannot be firmly attached to the housing; the woven appearance formed by CNC numerical control machine engraving is too imprecise and looks messy.

Therefore, there is room for improvement within the art.

### BRIEF DESCRIPTION OF THE FIGURES

Many aspects of the housing can be better understood with reference to the following figures. The components in the figures are not necessarily drawn to scale, the emphasis instead being placed upon clearly illustrating the principles of the housing. Moreover, in the drawings like reference numerals designate corresponding parts throughout the several views.

FIG. 1 is a cross-sectional view of an exemplary embodiment of a housing having a woven appearance.

FIG. 2 is a plane view of an exemplary embodiment of a housing having a woven appearance.

FIG. 3 is a plane, amplificatory view of an exemplary embodiment of a film used for forming the woven appearance.

### DETAILED DESCRIPTION

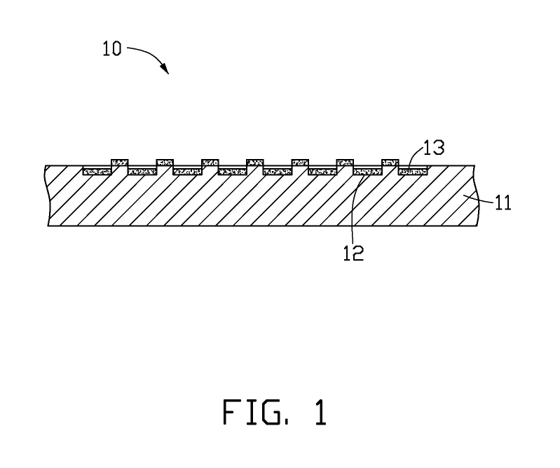

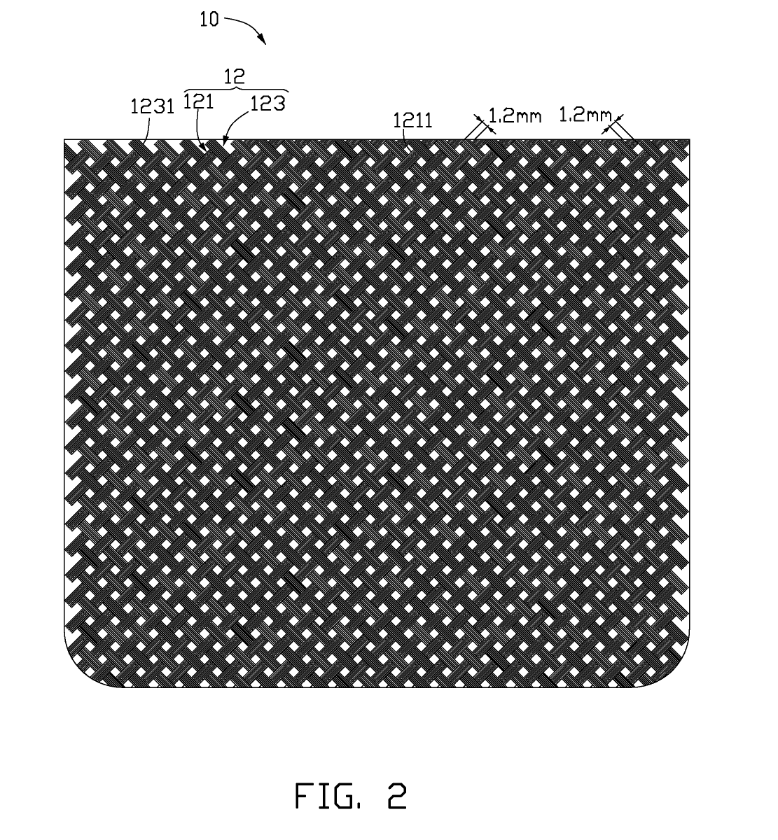

Referring to FIG. 1 and FIG. 2, in an exemplary embodiment, a housing 10 includes a substrate 11. The substrate 11 is formed with a plurality of groove groups 12 therein. A decorative coating 13 is formed in the groove groups 12 and on the substrate 11.

The substrate 11 may be, for example, made of metal selected from a group consisting of aluminum, aluminum alloy, titanium, titanium alloy and stainless steel.

The groove groups 12 define a predetermined woven appearance. The groove groups 12 include a plurality of first groove groups 121 arranged in a parallel and uniformly spaced interval and a plurality of second groove groups 123 arranged in an another parallel and uniformly spaced interval. That is groove groups 123 are arranged in the intervals between groove groups 121 so that the first groove groups 121 and the second groove groups 123 appear to cross each other in a woven pattern. Distances between groove groups are determined by desired woven appearance, e.g., tight weave, loose weave, etc.

Each of the first groove group 121 includes a plurality of uniformly spaced parallel first grooves 1211. Each of the second groove group 123 includes a plurality of uniformly spaced parallel second grooves 1231. The depth of each first groove 1211 and each second groove 1231 can be about 0.03-0.05 mm, and preferably about 0.04 mm.

A method for making the groove groups 12 may comprise: providing a film having a lightproof areas and a light-transmissible areas, the lightproof areas defining a woven appearance; providing a metal substrate having light-sensitive materials formed thereon; placing the film on the substrate and radiating the film with light, the light passing through the light-transmissible areas of the film and solidifying the light-sensitive materials; removing the film from the substrate, cleaning un-solidified light-sensitive materials from the substrate to expose areas corresponding to the lightproof area; and etching the substrate in the exposed areas to form a woven appearance. Each step is described in greater detail below.

Light-sensitive inks are printed on exterior surface of the substrate 11. The light-sensitive inks can be solidified and firmly adhered to the substrate 11 by being radiated with light. The solidified light-sensitive inks can undergo rinsing with strong acids to clean away any un-solidified ink.

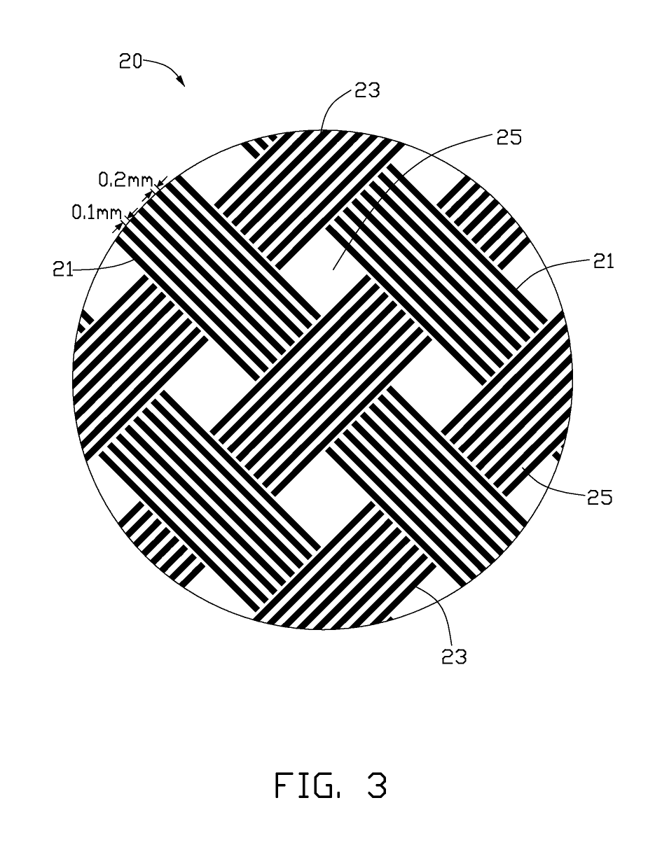

Referring to FIG. 3, a film 20 is provided. The film 20 has a plurality of groups of first lightproof areas 21, a plurality of groups of second lightproof areas 23 arranged in the intervals between the groups of first lightproof areas 21 so that the groups of first lightproof areas 21 and second lightproof areas 23 appear to cross each other in a woven pattern, and a plurality of light-transmissible areas 25. These groups of first lightproof areas 21, second lightproof areas 23 and light-transmissible areas 25 cooperatively forming a woven appearance. The groups of first lightproof areas 21 and second lightproof areas 23 have light-sensitive materials adhered thereto, such as opaque light-sensitive glues. The light-transmissible areas 25 can be transparent or translucent; excluding light-sensitive materials.

The film 20 is placed on the exterior surface of the substrate 11. The film 20 is then radiated with light, and the light-sensitive inks on the substrate 11 corresponding to the light-transmissible areas 25 are solidified and firmly adhered to the substrate 11 by the light passing through the light-transmissible areas 25. The light-sensitive inks on the substrate 11 corresponding to the groups of first lightproof areas 21 and second lightproof areas 23 remain un-solidified.

The film 20 is then removed from the substrate 11 to clean the surface of the substrate 11. At this stage, any un-solidified light-sensitive ink is cleaned from the substrate 11 by using acid as mentioned above, and the surface of the substrate 11 corresponding to the groups of first lightproof areas 21 and second lightproof areas 23 is exposed. The surface of the substrate 11 corresponding to the light-sensitive areas 25 are covered by the solidified light-sensitive inks.

The exposed areas of the substrate 11 are then chemically etched to form the groove groups 12. The chemical etching process may be carried out by spraying an etching solution to the exposed areas. The etching solution may be a hydrochloric acid solution containing a ferric chloride compound. In this embodiment, the spraying pressure is about 0.25 Mpa. The pH value of the etching solution is about 0.8-1.5. The spraying process may last for about 540 seconds. The depth of each groove of the groove groups 12 is about 0.03-0.05 mm. The chemical etching process can also be carried out by dipping the substrate 11 in the etching solution for a period of time to form the groove groups 12. After the etching step, the substrate 11 is rinsed in water. Then, the solidified light-sensitive inks are removed from the substrate 11.

The arrangement of the first groove groups 121 and the second groove groups 123 on the housing 10 is corresponding to the arrangement of the groups of first lightproof areas 21 and second lightproof areas 23 of the film 20.

The decorative coating 13 may be formed by spraying paint or vacuum depositing and consists one or more colors.

It should be understood, the woven appearance formed on the housing 10 is not limited to the pattern described in this embodiment. The woven appearance can be diversified cross grooves.

It should be understood, the groove groups 12 can also be formed by laser etching or sand blasting the surface of the substrate 11.

The woven appearance formed on the housing 10 by the above process has a strong three-dimensional appearance. The grooves to form the woven appearance are precise, which give the housing 10 a more attractive appearance.

It should be understood, however, that even though numerous characteristics and advantages of the present embodiments have been set forth in the foregoing description, together with details of functions of the embodiments, the disclosure is illustrative only, and changes may be made in detail within the principles of the invention to the full extent indicated by the broad general meaning of the terms in which the appended claims are expressed.

What is claimed is:

1. A housing having a woven appearance, comprising:
a substrate; and
a plurality of groove groups formed on the surface of the substrate;
wherein the groove groups define a woven appearance and are formed by etching.

2. The housing as claimed in claim 1, wherein the groove groups include a plurality of first groove groups arranged in a parallel and uniformly spaced interval and a plurality of second groove groups arranged in the intervals between the first groove groups.

3. The housing as claimed in claim 2, wherein each of the first groove group includes a plurality of uniformly spaced parallel first grooves; each of the second groove group includes a plurality of uniformly spaced parallel second grooves.

4. The housing as claimed in claim 1, wherein the housing further includes a decorative coating formed in the groove groups and on the surface of the substrate.

5. The housing as claimed in claim 4, wherein the decorative coating is a painted coating or a vacuum depositing coating.

6. A method for making a housing having a woven appearance, comprising:
providing a film having a lightproof areas and a light-transmissible areas, the lightproof areas defining a woven appearance;
providing a metal substrate having light-sensitive materials formed thereon;
placing the film on the substrate and radiating the film with light, the light passing through the light-transmissible areas of the film and solidifying the light-sensitive materials;
removing the film from the substrate, cleaning un-solidified light-sensitive materials from the substrate to expose areas corresponding to the lightproof area;
etching the substrate in the exposed areas to form a woven appearance.

7. The method as claimed in claim 6, wherein the lightproof areas have light-sensitive opaque light-sensitive glues adhered thereto.

8. The method as claimed in claim 6, wherein the lightproof areas includes a plurality of groups of first lightproof areas and a plurality of groups of second lightproof areas arranged in the intervals between the groups of first lightproof area.

9. The method as claimed in claim 6, wherein the substrate is made of metal selected from a group consisting of aluminum, aluminum alloy, titanium, titanium alloy and stainless steel; the light-sensitive materials formed on the substrate is light-sensitive inks.

10. The method as claimed in claim 9, wherein the etching process includes chemical etching, laser etching and sand blasting etching.

11. The method as claimed in claim 10, wherein the chemical etching process is carried out by using an etching solution containing ferric chloride compound with a pH value of about 0.8-1.5.
